(19) United States
(12) Patent Application Publication
(10) Pub. No.: US 2011/0066466 A1
(43) Pub. Date: Mar. 17, 2011

(54) METHOD AND SYSTEM FOR GENERATING TRANSITION PLANS FOR APPLICATIONS OF ORGANIZATIONS

(75) Inventor: Lakshmi Narasimhan Narayanan, Chennai (IN)

(73) Assignee: INFOSYS TECHNOLOGIES LIMITED, Bangalore (IN)

(21) Appl. No.: 12/907,234

(22) Filed: Oct. 19, 2010

Related U.S. Application Data
(63) Continuation-in-part of application No. 12/362,578, filed on Jan. 30, 2009.

(30) Foreign Application Priority Data
Feb. 1, 2008 (IN) 272/CHE/2008
Jun. 18, 2010 (IN) 1701/CHE/2010

(51) Int. Cl. G06Q 10/00

(52) U.S. Cl. 705/7.36

(57) ABSTRACT

A method and a system for generating one or more transition plans for one or more applications of an organization are provided. Transition information for identifying a set of applications for transition is obtained from information corresponding to the one or more applications. One or more groups of the identified set of applications are created. Further, one or more activities for transition execution are identified for each application of the identified set of applications. Thereafter, one or more transition plans comprising the one or more identified activities are generated.

### CROSS-REFERENCE TO RELATED APPLICATIONS

This application is continuation-in-part of U.S. application Ser. No. 12/362,578, filed on Jan. 30, 2009, the disclosure of which is incorporated herein by reference.

### BACKGROUND OF THE INVENTION

The invention relates, generally, to the field of transition of one or more applications of an organization to a different organization and/or location. More specifically, the invention relates to a method and a system for generating one or more transition plans for supporting transition of the one or more applications.

The transition of applications involves the transfer of management, support, and execution of an entire set of applications within a business function to an external service provider. The applications that are transferred to the external service provider (or vendor) may include, software or Information Technology (IT) applications; and applications supporting infrastructure. A transfer agreement defining transferred services is signed between a client and a supplier (or the external service provider). The transferred services include knowledge transition, and transfer of people, assets and other resources from the client. Knowledge transition includes due diligence, transition planning, knowledge transfer, secondary and primary support, transition closure, and steady state. Due diligence involves obtaining a snapshot of the current portfolio (or the set of applications being transferred) and analyzing data collected for the portfolio and generate an optimal transition plan and cost of maintenance and support work in steady state phase. Transition planning is performed by a transition manager who monitors and tracks transition progress. The transition progress status reports are collated and circulated to stakeholders. Further, knowledge transfer involves transfer of the knowledge from a first set of users, such as incumbent team, to a second set of users, such as vendor team. In secondary and primary support phase, the work of maintaining and supporting applications is gradually handed over to the vendor team. The transition closure ensures readiness of the vendor team to take complete control of the work and necessary performance goals are set in place for tracking during the steady state. Furthermore, steady state involves the vendor team taking complete ownership of maintenance and support of the applications.

In the current scenario, all application transitions are following a predetermined transition approach irrespective of the context in which the transition has to take place. Therefore, there is no transition-process tailoring with regard to the context and this may lead to improper transition planning and thus a significant waste of effort. Further, the application portfolio analysis is performed using a common approach using custom tools or performed in an ad-hoc manner without using any tool. The application portfolio analysis focuses only on transition solution and cost of maintenance of the applications in the steady state and thereby does not provide direction towards improvements to the portfolio in terms of transformation opportunities. Also in the transition scenarios where there is less information available with client about an application, there are no reference scoring models that can be referred based on the business domain of the application portfolio. Moreover, the analysis of the applications is performed manually. The analysis process becomes tedious and laborious with an increase in the number of applications in the portfolio. Further, the current approach does not capture information of a particular application from multiple stakeholders' point of view, leading to a discrepancy in understanding. This leads to more assumptions in decision making as a part of transition planning. Further, no feedback process is followed and each portfolio analysis engagement has to re-invent the wheel and there is a heavy dependence on few experts to perform the transition activity successfully, which results in a poor scalability.

In light of the foregoing, there is a need for a method and a system which enable accelerated and effective transition using a context-based, collaborative and comprehensive transition approach. The approach should be customizable to ensure that there is no case of only one size solution that fits for all types of transition. The method and the system should provide holistic view of applications from multiple view points and reference models so as to take informed decisions and also enable identification of transformation opportunities (or areas of improvements). The invention should enable building of application scoring models for a particular domain over a period of time. The invention should also enable closed-loop learning, where learning from the transition are captured and shared with the users.

### BRIEF SUMMARY OF THE INVENTION

An object of the invention is to facilitate context-based generation of one or more transition plans for one or more applications of an organization.

Another object of the invention is to provide a data-driven approach for generating the one or more transition plans to reduce dependency on expertise and experience of few users such as transition manager.

Another object of the invention is to facilitate multi-dimensional assessment of the one or more applications for transition from multiple stakeholders' point of view.

Another object of the invention is to facilitate building of knowledge on application scoring models for a particular domain over a period of time.

Another object of the invention is to facilitate identification of transformation opportunities within a portfolio.

To achieve the above-mentioned objectives, the invention provides a method and a system for generating the one or more transition plans for the one or more applications of the organization based on the context that is derived from transition information captured as a part of portfolio analysis. The one or more applications support at least one function of the organization. Transition information is obtained from information corresponding to the one or more applications. The transition information is used for identifying a set of applications for transition. Further, one or more groups of the identified set of applications are created. Thereafter, based on the transition information and one or more transition rules, one or more activities are identified for transition execution. The one or more activities are identified for each application of the identified set of applications in the one or more groups. Subsequently, the transition plans comprising the one or more identified activities corresponding to the identified set of applications are generated. The approach for the generation of the transition plans is based on facts and data driven.

The invention also provides a method and system for multi-dimensional assessment of the applications for transition from multiple stakeholders thereby identifying transformation opportunities and also facilitates building of knowledge on the application scoring models for a particular domain over a period of time and post transition learning's.

The method and the system described above have a number of advantages. The method and the system facilitate multi-dimensional and context-based transition approach for effective transition. Further, the present invention enables closed-loop learning by capturing information gaps and by sharing the learning's from the transition with the users, post transition. It enables building of knowledge on application scoring models or historical information for various portfolios/domains over a time period which can later be used as a reference. It also provides collaboration between stakeholders to analyze the portfolio, thereby providing a holistic view of applications from multiple stakeholders' view points. The present invention reduces the dependency on transition manager's expertise and experience by using a data driven approach for generating the transition plans.

### BRIEF DESCRIPTION OF THE DRAWINGS

Various embodiments of the invention will hereinafter be described in conjunction with the appended drawings, provided to illustrate, and not to limit, the invention, wherein like designations denote like elements, and in which:

FIG. 1 is a flowchart illustrating a method for generation of one or more transition plans for one or more applications of an organization, in accordance with an embodiment of the invention;

FIG. 2 is a flowchart illustrating a method for assessing the one or more applications for transition, in accordance with an embodiment of the invention;

FIG. 3 is a flowchart illustrating a method for the transition of the one or more applications of the organization, in accordance with an embodiment of the invention;

FIG. 4 illustrates a snapshot of a graphical representation of one or more groups, in accordance with an embodiment of the invention;

FIG. 5 illustrates a transition planning model for identifying one or more transition activities, in accordance with an embodiment of the invention;

FIG. 6 illustrates a snapshot of a transition portfolio dashboard, in accordance with an embodiment of the invention;

FIG. 7 is a block diagram of a system for the generation of the one or more transition plans for the one or more applications of the organization, in accordance with an embodiment of the invention; and

FIG. 8 is a block diagram of a system for assessing the one or more applications for transition, in accordance with an embodiment of the invention.

### DETAILED DESCRIPTION

The invention describes a method, a system and a computer program product for supporting transition of one or more applications of an organization. The transition of the applications includes service transfer of maintenance and support of the applications, along with knowledge or information associated with the applications. The applications are transitioned from a first set of users to a second set of users. One or more transition plans are generated for each of the one or more applications. Transition information used for identifying a set of applications for transition is obtained from information corresponding to the one or more applications. Further, one or more groups of the identified set of applications are created. Furthermore, one or more activities for each application of the identified set of applications are identified for transition execution. One or more transition plans comprising the identified set of activities are generated.

The invention further describes a method, a system and a computer program product for assessing the one or more applications. A first set of scores is defined by a first set of users based on the information corresponding to the one or more applications. Further, a second set of scores is defined by a second set of users based on one or more historical scores stored in a repository. The first set of scores and the second set of scores are validated by the first set of users and the second set of users. The one or more applications are assessed based on the validated set of scores.

An organization uses several applications for supporting its various functions or business needs, for example, Information Technology (IT), business processes, Human Resources (HR), and so forth. The applications are transitioned by the organization such that the applications are supported from same and/or a different location and by a different set of users of same and/or a different organization.

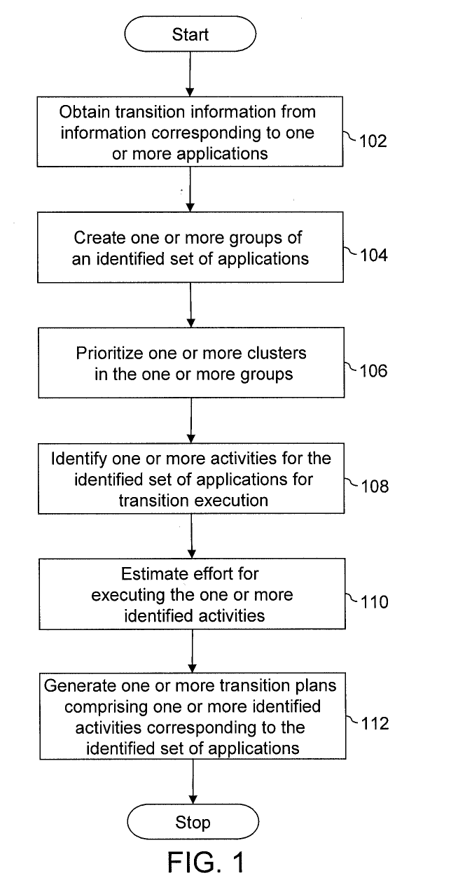

FIG. 1 is a flowchart illustrating a method for the generation of the one or more transition plans for the one or more applications of the organization, in accordance with an embodiment of the invention.

In various embodiments of the invention, the method illustrated in FIG. 1 is suitable for use in the transition of the one or more applications of the organization. The method enables a user to generate the one or more transition plans to support and manage the transition of the one or more applications of the organization.

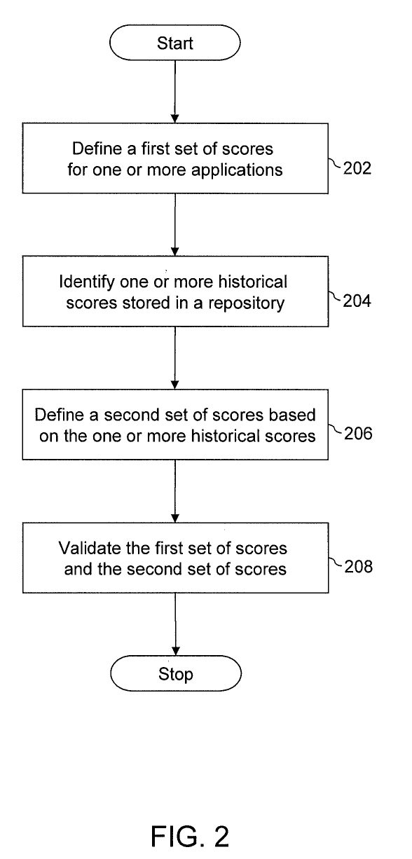

At 102, transition information is obtained from information corresponding to the one or more applications. The information corresponding to the one or more applications (also referred to as application information) includes information describing the applications; for instance, business domain of the application, complexity, criticality and stability of the applications, and so forth. The information corresponding to the applications also includes information describing the environment in which the application is implemented, for example, programming language of the application, security compliance, and so forth. At 102, each of the one or more applications is assessed for obtaining the transition information. The assessment of the applications is performed based on the information corresponding to the one or more applications. The application information obtained from all stakeholders such as business group, IT management group, and service provider is used for assessing the applications for transition. The assessment of the one or more applications of the organization has been explained in detail in conjunction with FIG. 2.

The information corresponding to the applications is captured using various tools and methods such as interview questionnaires and interview guides, reference application information, document repository tracker, RASCI matrix, 720-degree framework, due diligence plan and defined application attributes for analysis. The various tools and/or methods have been explained in detail at the end of description of FIG. 1, after explaining the complete method for generating the transition plans.

The above mentioned tools and/or methods are then used for obtaining the transition information. The reference application information for each portfolio is uploaded in to a system and gaps are identified in the reference application information based on the defined application attributes. Interview sessions are conducted with client SMEs using the interview questionnaires and interview guides. Thereafter, the application information gaps are closed based on the interview-session information. The updated application information is uploaded into the system for each portfolio and the client SME is requested to validate the information. Thereafter, the application information is baselined and is subsequently made available to all stakeholders for reference.

The transition information includes the application information along with information captured in various dimensions such as portfolio complexity, engagement characteristics, and transition scenarios. The various dimensions of the transition information have been explained in detail at the end of description of FIG. 1, after explaining the complete method for generating the transition plans. The transition information along with execution risk is then used for identifying a set of applications for transition. The execution risk is defined based on risks driven from various factors such as engagement commitments, including Service Level Agreements (SLAs); contracts; financials; and resource capability, including team, infrastructure, and knowledge in domain. The set of applications is identified from the one or more applications of the organization.

At 104, one or more groups (also referred to as waves) of the identified set of applications are created. A group is defined as a unit of transition period. It guides or enables the transition manager to formulate an execution plan for the transition. The one or more groups of the identified set of applications are created based on a predefined set of criteria. The one or more groups are also sequenced or prioritized for transition execution based on the predefined set of criteria. The predefined set of criteria includes various attributes such as gradual ramp up of steady state team, enabling learning across groups, SME requirement, transition risk, and scheduling constraint. The different types of groups/waves created or designed based on the various values of the predefined set of criteria are illustrated in Table 1.

TABLE 1
Wave designing options based on the predefined set of criteria

| Attributes | Wave design option |
|---|---|
| Gradual ramp up of steady state team = Yes | Wave design = Sequenced |
| Enable learning across waves = Yes | The wave design does not |
| SME requirement = Medium | tie/bind the particular wave |
| Transition risk = Low | or cluster to dates. |
| Scheduling constraint = Flexible | |
| Gradual ramp up of steady state team = No | Wave design = Parallel |
| Enable learning across waves = No | The wave design ties/binds |
| SME requirement = High | the particular wave or |
| Transition risk = High | cluster to dates. |
| Scheduling constraint = Inflexible | |
| Gradual ramp up of steady state team = No | Wave design = Parallel |
| Enable learning across waves = No | The wave design ties/binds |
| SME requirement = Medium | the particular wave or |
| Transition risk = Medium | cluster to either start or end |
| Scheduling constraint = Semi flexible | date. |
| Gradual ramp up of steady state team = Yes | Wave design = Sequenced- |
| Enable learning across waves = No | Parallel combination |
| SME requirement = Medium | |
| Transition risk = Medium | |
| Scheduling constraint = Flexible | |

Each of the one or more groups comprises one or more clusters. Each of the one or more clusters comprises the identified set of applications. A cluster is defined as a logical grouping of applications based on various factors such as synergies between applications in terms of technology, domain, lines of business, manager-in-charge; dependencies among applications being clustered; and involving manageable number of resources. The clusters are mapped to the one or more groups based on various factors such as cluster criticality and cluster transition risk. The cluster criticality and cluster transition risk are derived from stability and complexity ratings of the applications listed within the cluster. Table 2 illustrates a mapping of the clusters to groups.

TABLE 2
Mapping of cluster to group

| | Cluster | Cluster |
|---|---|---|
| Group | Transition Risk | Criticality |
| 1 | High | High |
| 2 | High | Low |
| 3 | Low | High |
| 4 | Low | Low |

The creation of the groups and clusters make the transition process more manageable, predictable, and accurate by dividing the major tasks into smaller sub-tasks. Further, the learning from each group can be used to improve transition execution effectiveness and efficiency of the subsequent groups. In an embodiment of the invention, the one or more groups and clusters are created by the transition manager.

In an embodiment of the invention, at 104, the one or more clusters containing different applications are assessed on the basis of one or more scores of the applications included in the corresponding clusters. Various scoring techniques are used to determine the scores of the applications as explained in conjunction with FIG. 2. The applications are provided scores on the basis of different parameters or dimensions such as complexity, stability, and criticality. Therefore, the assessment of the clusters includes a multi-dimensional analysis of the information corresponding to the applications. The complexity assessment of the applications within the clusters determines the complexity rating of the corresponding cluster. Each application is marked or rated as simple, medium, or complex based on its complexity. Similarly, other application dimensions such as stability, and criticality help in determining cluster stability, and cluster criticality respectively. It will be evident to a person skilled in the art that a rating or score of an application can be denoted in various formats and also the rating or scores can be divided into multiple categories or levels. The complexity rating of a cluster is calculated by counting the number of applications rated as simple, medium, or complex. A cluster is provided a rating or score based on the application score that has the maximum number of applications within the cluster with that score.

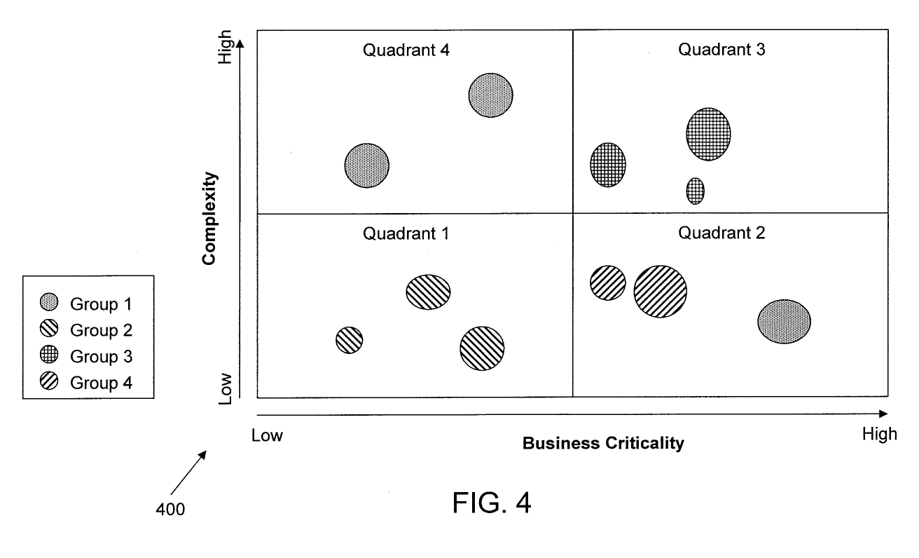

In an embodiment of the invention, at 104, a graphical representation of the one or more clusters is generated on the basis of the assessment of the clusters, i.e., one or more attributes of the applications such as complexity and criticality. Various clusters containing different applications and classified based on their business domains are represented graphically in various formats such as pie charts, scatter charts, and bubble charts. Further, at 104, a graphical representation of the one or more groups is generated as illustrated in FIG. 4. The graphical representation of the one or more groups is generated based on the various attributes such as complexity and business criticality.

At 106, the one or more clusters in the one or more groups are prioritized for transition sequencing. The prioritization or sequencing of the clusters within the groups is based on cluster transition risk or cluster stability which in turn depends on individual application stability ratings of the applications within the clusters. Table 3 illustrates the sequencing of the clusters within the groups.

TABLE 3
Sequencing of cluster within group

| Cluster Sequence | Cluster |
|---|---|
| Priority | Stability |
| 1. | Very High |
| 2. | High |
| 3. | Medium High |
| 4. | Medium |
| 5. | Medium Low |
| 6. | Low |

The prioritization of the one or more clusters includes prioritization of the identified set of applications in the one or more clusters. Each application is prioritized for transition sequencing in the corresponding cluster. The prioritization or sequencing of the applications depends on various factors such as application criticality and application complexity. Table 4 illustrates the sequencing of the applications within the clusters.

TABLE 4
Sequencing of application within cluster

| Application | | |
|---|---|---|
| Sequence | Application | Application |
| Priority | Criticality | Complexity |
| 1. | High | Low |
| 2. | High | High |
| 3. | Low | Low |
| 4. | Low | High |
| 5. | High | Low |
| 6. | High | High |
| 7. | Low | Low |
| 8. | Low | High |

In an embodiment of the invention, at 106, the sequencing or prioritization of the one or more groups, the one or more clusters in the one or more groups and the one or more applications in the one or more clusters is validated with the client. Further, the one or more scores of the applications and the clusters are validated with the client. The graphical representation of the clusters and the groups assist the client in validating the transition sequencing. The sequencing and logical grouping of the applications, clusters, and groups optimize duration, and effort, and reduces risk in the transition process.

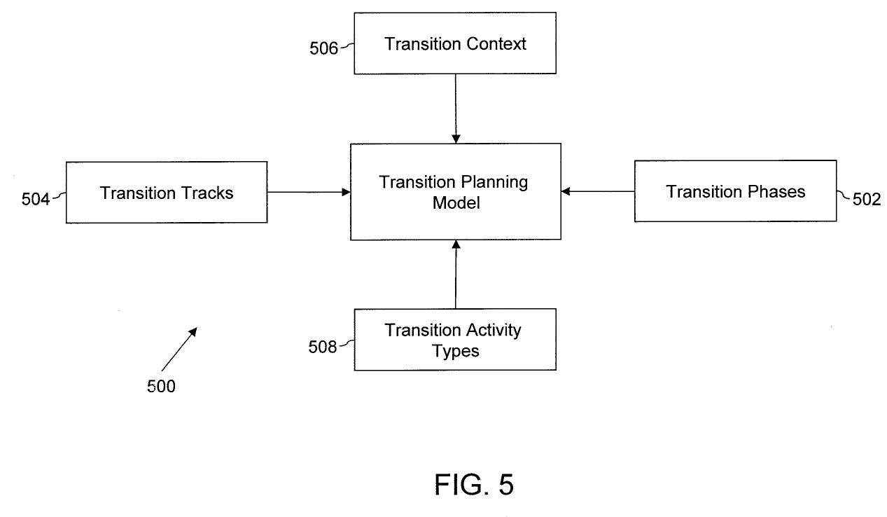

At 108, one or more activities, also referred to transition activities, are identified at each application level for transition execution. The transition activities refer to the activities or tasks that need to be performed during different phases of the transition process, for example, due diligence, transition planning, knowledge transfer, secondary support, primary support, and transition closure. The one or more activities are identified for each application of the identified set of applications in the one or more groups. The one or more activities are identified based on the transition information and one or more transition rules. The one or more transition rules comprise at least one of one or more knowledge focus areas, one or more transition phases, one or more transition tracks, and one or more transition activity types. The identification of the one or more activities has been explained in detail in conjunction with FIG. 5.

At 110, effort for executing each of the one or more identified activities is estimated. In an embodiment of the invention, the effort is estimated using either of the two approaches/methodologies—bottom-up approach and top-down approach. The bottom-up approach uses an estimation model for estimating the effort. The estimation model is defined based on the complexity of the application. For each of the identified set of applications, various points/scores are calculated based on various dimensions such as functional, service delivery, value adjustment, and productivity drivers. Each of these dimensions further includes various attributes which are used for calculating the points. Functional points are calculated based on various attributes such as domain, application complexity, and stability. Service delivery points are calculated based on criticality and service complexity. The various attributes of value adjustment such as scope clarity, client readiness, and transition risks are used for calculating value adjustment factor and various attributes of productivity drivers such as SME availability, process or tools maturity, and level of documentation are used for calculating productivity driver scale. A transition complexity scale is calculated based on the functional points, the service delivery points, and the value adjustment factor. The transition complexity scale and the productivity driver scale in addition to the number of Full-Time Equivalents (FTE) for portfolio steady state are then used for estimating the total transition effort. Table 5 illustrates an effort estimate for each of the activities in the various transition phases.

TABLE 5
Effort Estimate for Transition Phases and Activities

| | | Effort in person hours | | |
|---|---|---|---|---|
| # | Transition Phase | Simple | Medium | Complex |

| | |
|---|---|
| 1 | System |
| | Appreciation |
| 2 | Secondary Support |
| 3 | Primary Support |
| 4 | Steady state |
| | Readiness |

As shown above, the estimation model estimates the effort required for executing each of the one or more identified activities for each application. The estimated effort for each of the application is aggregated to calculate the effort estimate for each of the one or more clusters. The effort estimate for each of the one or more clusters is further aggregated to calculate the effort estimate for each of the one or more groups/waves.

The top-down approach for effort estimation uses three analytical models for effective transition planning—wave model, cluster model, and application model. The wave model helps in determining right number of waves and average wave duration that needs to be defined based on historical information. The input to the wave model is based on following key information collected as part of due diligence exercise—business function/domain, number of applications, percentage (%) of critical application, percentage (%) of complex application, and number of transition execution locations. The output from the wave model is represented in a tabular format as shown in Table 6.

TABLE 6
Output of Wave model of effort estimation

| | | | | No. of | | Avg. Wave | |
|---|---|---|---|---|---|---|---|
| Business | | % of | % of | transition | Total | duration | |
| function/ | No. of | critical | complex | execution | No. of | (weeks) | |
| Domain | applications | application | application | locations | waves | Short | Long |

The cluster model helps in determining the right number of clusters and average cluster duration that needs to be defined based on historical information. The input to the cluster model is based on following key information: number of applications, percentage (%) of critical application, and percentage (%) of complex application. The output from the cluster model is represented in a tabular format as shown in Table 7

TABLE 7
Output of Cluster model of effort estimation

| | | | | | | | |
|---|---|---|---|---|---|---|---|
| | | | | Avg. | | | |
| | % of | % of | Total | cluster | Avg. | Avg. | Avg. |
| No. of | critical | complex | no. of | duration | Cluster | clusters/ | Apps/ |
| applications | application | application | clusters | (weeks) | complexity | wave | Cluster |

The application model helps in determining the average application transition duration etc that needs to be defined based on historical information. The input to the application model is based on following key information: technology and business process/function. The output from the application model is represented in a tabular format as shown in Table 8.

TABLE 8
Output of Application model of effort estimation

| Key Generic | | | | | |
|---|---|---|---|---|---|
| Business | | Avg. | Avg. | Avg. | Avg. KT |
| Process | Tech- | no. | transition | KT | performance |
| enabled | nology | of FTE | duration | duration | rating |
| Manage | | | | | |
| product and | | | | | |
| service portfolio | | | | | |
| OR | | | | | |
| Market and Sell | | | | | |
| Products and | | | | | |
| Services OR | | | | | |
| Deliver | | | | | |
| Products and | | | | | |
| Services OR | | | | | |
| Manage | | | | | |
| Customer | | | | | |
| Service OR | | | | | |
| Manage | | | | | |
| Human Capital | | | | | |
| OR | | | | | |
| Manage | | | | | |
| Financial | | | | | |
| Resources OR | | | | | |
| Manage IT | | | | | |
| resources | | | | | |

Based on the above three analytical models, the transition timelines can be derived specific to the context. The information from the bottom-up estimation approach which focuses on effort estimate and the top-down estimation approach which focuses on timelines and team required (FTE) for execution is cross verified by the transition manager and a final estimate is base-lined.

At 112, one or more transition plans are generated. The one or more transition plans include the one or more identified activities corresponding to the identified set of applications. The generation of the transition plans includes defining transition estimates based on the complexity of the activity. The transition estimates include estimation of the total transition effort and schedule. Firstly, resources such as workforce are assigned to each of the one or more identified activities in the one or more transition plans. Thereafter, effort and timelines for the execution of the one or more identified activities are estimated. The effort estimation has been explained in detail in conjunction with step 110. Further, a schedule or timelines for the execution of the identified activities is defined by a user such as a transition manager. The schedule is defined at a group level, a cluster level, and an application level. The defining of the schedule includes defining dependencies within the various activities at the application level, the cluster level, and the group level.

At 112, the transition plans corresponding to the identified set of applications are aggregated. The aggregation of the transition plans is based on the one or more groups and the one or more clusters. The transition plans corresponding to the applications in a single cluster are aggregated. Thereafter, the transition plans corresponding to all the clusters in a group/wave are aggregated, and thus an aggregated transition plan (also referred to as a group-level transition plan) is created.

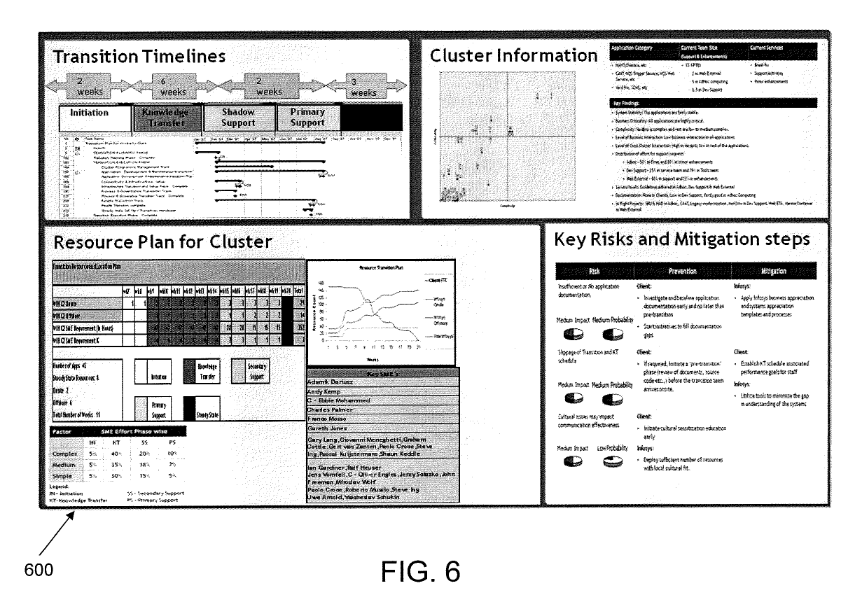

At 112, one or more risks associated with each of the one or more identified activities are also identified. The risks and/or issues are identified at each of the levels, i.e., at an activity level, the application level, the cluster level and the group level. Further, the one or more transition plans are organized at 112 based on the one or more identified risks and/or issues. Thereafter, at 112, a graphical representation of the one or more organized transition plans is generated. The graphical representation of the one or more organized transition plans is illustrated in FIG. 6. The one or more organized transition plans are finally presented to the client. The transition of the one or more applications is executed based on the one or more organized transition plans.

The method for generation of transition plans as explained in conjunction with FIG. 1 has been summarized as follows:
Perform portfolio analysis/assessment based on the transition information
Define a number of waves or groups based on portfolio size and wave definition rule (predefined set of criteria)
Define a number of clusters based on portfolio size and cluster definition rule (predefined set of criteria)
Map the clusters to the corresponding waves based on wave mapping rule (predefined set of criteria)
Define a cluster sequence based on cluster sequence rule
Define an application sequence based on application sequence rule
Select relevant application tracks based on risk ratings
Select at application level, relevant transition phases based on criticality and complexity rating
Identify application level knowledge focus areas based on complexity, stability, service delivery, and criticality ratings
Calculate phase level estimates for transition execution based on application transition size and productivity drivers
Select transition activity types for each phase based on knowledge focus areas, engagement characteristics, and transition scenarios
Select activities based on transition activity types
Generate application level plan based on the selected activities, estimates and selected transition phases
Baseline or organize application level plan schedule by resource allocation to tasks/activities
Define cluster level plan based on the application level plan aggregation
Define wave/group level plan based on the cluster level plan aggregation

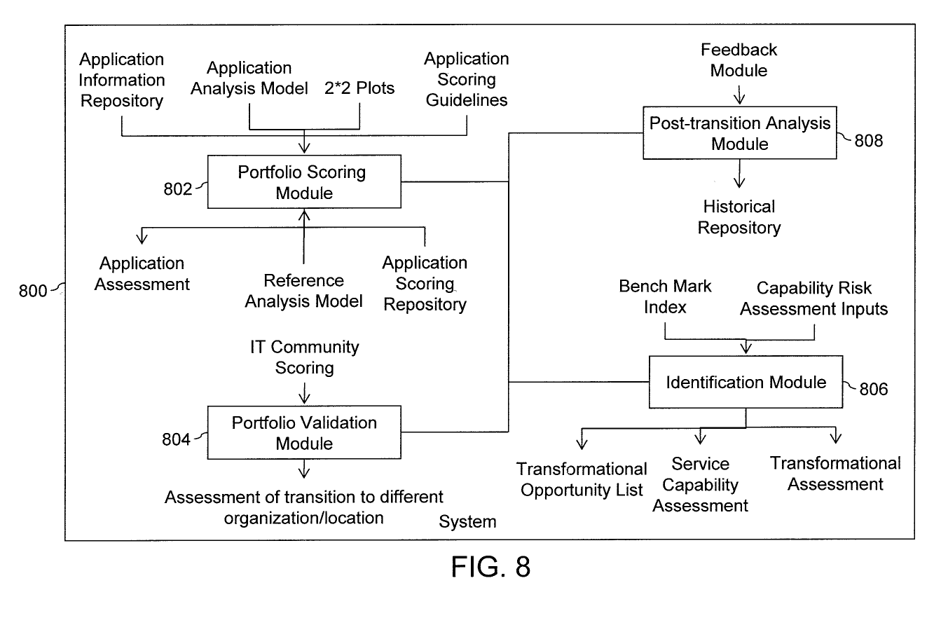

As explained in conjunction with 102, the various tools and/or methods used for capturing the application information are as follows:
Interview questionnaires and interview guides: The interview questionnaires and interview guides provide a structured process for capturing all information from various users (also referred to as the stakeholders) such as business users/owners, portfolio owners, application owners, Subject-Matter Experts (SMEs), application support team, i.e., person(s) using and/or managing the applications in the organization. The interview guides also ensure that all key information is captured in a short time. The interview guide includes information such as scope of interview, i.e., the list of users to be questioned, and documents required from the client to supplement the interviews.
Document Repository Tracker: The document repository tracker keeps a track of the availability and quality of the documents provided by the client. Some of the documents include overview document, service delivery document, business process document, support manual, and so forth.
RASCI matrix: The Responsible, Approval, Support, Consult and Inform (RASCI) matrix ensures that all stakeholders are aware of their roles and responsibilities.
720-degree framework: The 720-degree framework provides a holistic view of the portfolio in various dimensions such as business and IT group, application support, historical data, and transition capabilities. The 720-degree framework assists in assessing or evaluating transformation opportunities available for bringing alignment between business and IT. The 720-degree framework provides support to assess the strength of the applications in terms of transition to a different organization and/or location and the current support capability. The 720-degree framework has been explained in detail in conjunction with FIG. 8.
Defined application attributes: The application attributes include complexity such as application and service complexity; supportability in terms of application stability and process maturity; transition risk; and criticality such as business and onsite criticality. Each of the application attributes is assigned a weightage and a score is calculated for each attribute based on predefined scoring guidelines. The scores of the application attributes are used for generating an analysis model.
Due diligence plan: The due diligence plan is a project plan component for tracking the portfolio analysis activities. The due diligence plan includes the following set of phases: due diligence preparation, initiation, execution, and closure.

As explained in conjunction with 102, the various dimensions for capturing the transition information are as follows:
Portfolio Complexity: The portfolio complexity, also referred to as portfolio assessment, provides details about functional, technical, and service complexity and operational risks about each of the application in the IT portfolio. This detail helps in designing the solution for taking over the application for maintenance and support work. Portfolio complexity includes attributes such as complexity, criticality, stability, and application significance. Each of these attributes includes multiple sub-attributes. For example, complexity includes technology complexity, service delivery complexity, and functional complexity. Criticality corresponds to business criticality whereas stability corresponds to application stability. Application significance includes strategic significance, replacement strategy, and enhancement strategy.
Engagement Characteristics: The engagement characteristics provide details about key objectives of the client for the transition. Special needs in terms of support requirements such as language support, staff augmentation, rebadging goals, need for non-intrusive transition, contractual requirements, legal/compliance requirements are a part of the engagement characteristics. The engagement characteristics include various attributes such as environment, context, and risk. Each of these attributes includes multiple sub-attributes. For example, environment includes multi-location support need, language or translation requirement, multi vendor scenario, security compliance, and process maturity; context includes vendor domain experience, client relationship level, and rebadging needs; and risk includes client context and vendor context.
Transition Scenario: The transition scenario highlights the key challenges in transition. For example, lack of documentation, non availability of SME, and current application status are some of the key challenges. The transition scenarios include various attributes such as source code status, application status, SME status, and document status. Each of these attributes includes multiple sub-attributes. For example, source code status includes no source code, source code maintained by third-party product team, business group, incumbent vendor IT team, and client IT team; application status includes application available with business and not moved to production, application is in production, application is in development phase, and application is in deployment phase; SME status includes no SME available, SME not to be disturbed, SME on leave, SME available, SME reluctant to give knowledge; and document status includes no documents available, partial documents available, and documents available.

FIG. 2 is a flowchart illustrating a method for assessing the one or more applications for transition, in accordance with an embodiment of the invention.

In various embodiments of the invention, the method illustrated in FIG. 2 is suitable for use in assessing the one or more applications for transition from a first set of users to a second set of users. The method enables a user to support and manage the assessment of the one or more applications of the organization.

At 202, a first set of scores is defined for each of the one or more applications. The first set of scores is defined by the first set of users. The first set of users includes stakeholders from the IT management group, i.e., technology SME. It will be evident to a person skilled in the art that the first set of users can define the first set of scores in various ranges or scales. The first set of scores is defined based on information corresponding to the one or more applications. As explained in conjunction with FIG. 1, the information corresponding to the applications (also referred to as application information) includes information describing the applications for example, business domain of the application, complexity, criticality and stability of the applications, support process area, and so forth. The first set of scores will be defined based on application features in alignment with business process, application performance, and the application information.

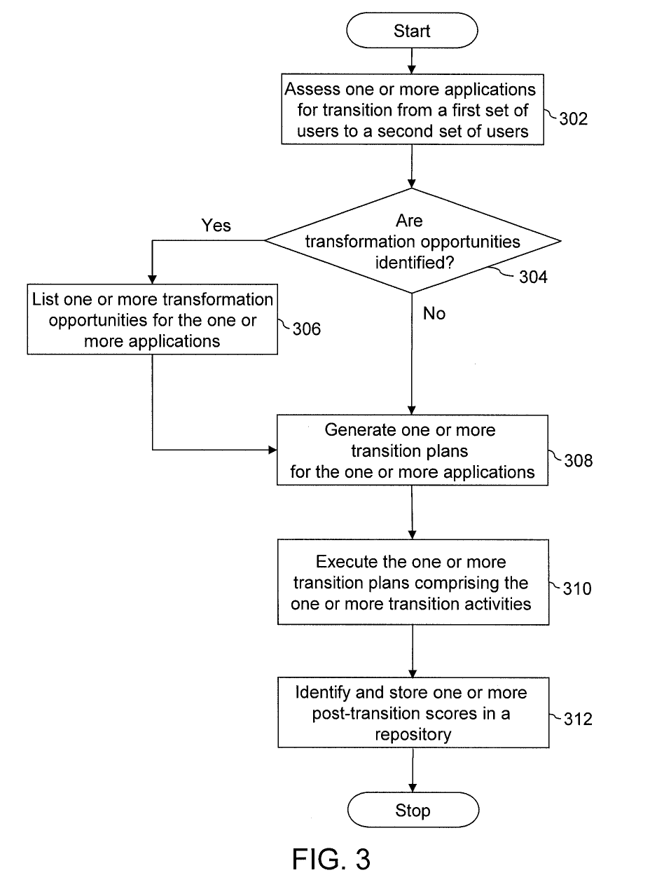

At 204, one or more historical scores are identified. The historical scores are stored in a repository (also referred to as historical repository). The one or more historical scores stored in the repository correspond to scores captured post the transition of the one or more applications. The historical scores are explained in detail in conjunction with FIG. 3.

At 206, a second set of scores is defined for each of the one or more applications. The second set of scores is defined by the second set of users. The second set of users includes stakeholders from the vendor or the service provider, assisting in the transition of the one or more applications. It will be evident to a person skilled in the art that the second set of users can define the second set of scores in various ranges or scales. The second set of scores is defined based on available transition information and one or more historical scores stored in a repository. The second set of users search the historical repository based on the business domain and key functionality of the application. Thereafter, the one or more historical scores are retrieved from the historical repository based on one or more dimensions such as transition risk, service complexity, ease of maintenance, and stability of the applications.

At 208, the first set of scores and the second set of scores are validated. The first set of scores and the second set of scores are compared to identify differences or gaps between them. The first set of scores and the second set of scores are then validated based on the identified differences. The first and the second set of scores are validated by the first set of users and the second set of users. The first set of scores and the second set of scores and the identified differences are presented to the first set of users and the second set of users for validation. The validated set of scores is used for assessing the one or more applications for transition. In an embodiment of the invention, the validated set of scores includes the scores that are identified from the first set of scores and the second set of scores based on the validation performed by the first set of users and the second set of users.

FIG. 3 is a flowchart illustrating a method for the transition of the one or more applications of the organization, in accordance with an embodiment of the invention.

In various embodiments of the invention, the method illustrated in FIG. 3 is suitable for use in the transition of the one or more applications of the organization. The method enables a user to support and manage the transition of the one or more applications of the organization.

At 302, one or more applications of the organization are assessed. The one or more applications are assessed for transition from a first set of users to a second set of users. The assessment of the one or more applications by the first set of users and the second set of users has been explained in detail in conjunction with FIG. 2. In an embodiment of the invention, the one or more applications are further assessed for identifying transformation opportunities for the one or more applications. A third set of scores are identified by a third set of users based on the validation of the first and second set of scores as explained in conjunction with FIG. 2. The third set of users is the business users who are using the one or more applications for day-to-day transactions. The applications are provided the third set of scores on the basis of different parameters or dimensions such as business value delivered, cost of service delivered, and quality of service provided and risk exposure.

At 304, a check for the transformation opportunities is performed. Based on the validated set of scores explained in detail in conjunction with FIG. 2 and the third set of scores, a correlation analysis is performed to check for the transformation opportunities. The transformation opportunities are the areas of improvement and areas of value addition to existing IT services and application portfolio in the context of value provided to business. The transformation opportunities are of three types: business level, technology, and process. At business level, the following are the areas of the opportunities:
a) Reducing working capital
b) Reduction in cost of operations
c) Increase in revenue
d) Reduction in time to market
e) Protection of brand value
   At technology level, the following are the areas of opportunities:
a) Legacy modernization
b) Portfolio rationalization
c) Business process rationalization or business process productivity improvement
   At process level, the following are the areas of opportunities:
a) Service Level Agreement (SLA) definition, tracking, and reporting
b) Support process automation
c) Knowledge management
d) Preventive maintenance which includes demand reduction, incident reduction, and alert rationalization
e) Continuous improvements
f) Support delivery model optimization
g) Process harmonization/standardization of process definition

The transformation opportunities are identified in the following manner. Firstly, the transformation opportunities are conceptualized to understand current business goals, IT strategic themes, and key focus areas. The current business goals are understood as a part of the due diligence or transition phase. The business goals are mapped to the key focus areas such as increasing revenues, decreasing costs, and governance & regulatory. Thereafter, the key business functions and the business processes that impact the business goals are identified.

The transformation opportunities are identified for improving the IT portfolio to better serve the business needs. The one or more applications are scored from the first set of users (for example, technology users) and the second set of users (for example, service providers) and the first set of scores and the second set of scores are further validated. The validated scores from the first set of users and second set of users along with the third set of scores are analyzed and operational improvement opportunities (process and technology) are identified. Based on the business goals and focus areas and current score differences between the business and technology users, the transformation opportunities are identified at strategic and operational level. At strategic level, technology initiatives are identified which are linked to business goals such as improving revenue, reducing cost of operations etc. At operational level, technology improvements and process improvement initiatives are defined based on the correlation analysis of the validated set of scores and the third set of scores along with bench mark values for the particular business process supported by the applications.

Finally, the key strategic themes and operational initiatives are shortlisted. Benefit areas are identified from the transformation opportunities and the benefits are quantified over a period using the cost-benefit analysis. The following set of operational initiatives is then shortlisted based on value, cost, risk, and flexibility parameters. The shortlisted ones are then reported to key business and IT users for budgeting and change management initiation approval.

At 306, the one or more transformation opportunities are listed. A typical listing of transformation opportunities is provided in Table 9.

TABLE 9
Transformation Opportunities

| Focus areas for | | | | | | | | | | |
|---|---|---|---|---|---|---|---|---|---|---|
| value adds/ | Operational | Process/ | Track | | Benefit | Benefits | | | | |
| improvements | initiatives | Steps involved | owner | Cost $ | Area | Yr 1 | Yr 2 | Yr 3 | Yr 4 | Yr 5 |

| | | | | | | | |
|---|---|---|---|---|---|---|---|
| IT Support | Process | Perform | XX | YY | Team | 5% | 3% |
| Process | Standardization | process | | | utilization | | |
| | | assessment | | | improvement | | |
| | | and evaluate | | | | | |
| | | process | | | | | |
| | | maturity | | | | | |

A transformation plan is prepared based on the operational initiatives and the transformation opportunities. The transformation plan provides details of the activities to be performed by the second set of users/service provider.

At 308, one or more transition plans are generated for the one or more applications. The one or more transition plans are generated for executing the transition of the one or more applications from the first set of users to the second set of users. The generation of the one or more transition plans has been explained in detail in conjunction with FIG. 1.

At 310, the one or more transition plans are executed. Each of the one or more transition plans includes one or more transition activities for execution. The one or more transition plans are executed for the transition of the one or more applications from the first set of users to the second set of users. The execution of the one or more transition plans for transition has been explained in detail in conjunction with previous U.S. application Ser. No. 12/362,578, titled “Framework for supporting transition of one or more applications of an organization” incorporated in its entirety by reference herein.

At 312, one or more post-transition scores are identified and stored in a repository. The post-transition scores include scores captured based on feedback from following areas/domains: wave and cluster performance, application scores, and application transition performance.

The wave and cluster performance or actual effort is evaluated in terms of a number of transition execution locations, total number of waves, average wave duration, the business function/domain, the total number of applications, and various other parameters of the wave model and the cluster model as explained in conjunction with FIG. 1.

The application scores are based on the scores provided for the one or more applications after the execution of the one or more transition plans. The one or more applications are scored by the second set of users (for example, service provider). The one or more applications are scored on various parameters or dimensions such as complexity, criticality, and stability. The one or more scores defined/identified after the execution of the transition are referred to as post-transition scores or historical scores.

The application transition performance is evaluated in terms of technology, average number of FTE, average transition duration, and various other parameters of the application model as explained in conjunction with FIG. 1.

The post-transition scores are stored in the repository (also known as historical repository). The post-transition scores are used in the assessment of the one or more applications in the subsequent transition processes as explained in conjunction with FIG. 2.

FIG. 4 illustrates a snapshot 400 of a graphical representation of one or more groups, in accordance with an embodiment of the invention. It will be evident to a person skilled in the art that snapshot 400 is a representation of the one or more groups of the one or more applications and that the one or more groups can be represented in various formats. Snapshot 400 includes various groups such as group 1, group 2, group 3, and group 4. Snapshot 400 illustrates the positioning/sequencing of the one or more waves or groups in terms of complexity and business criticality. The positioning of the one or more waves/groups further illustrates the positioning of the various clusters in the corresponding groups and the positioning of the one or more applications in the corresponding clusters. The one or more groups are positioned into one or more quadrants based on the rating or score provided to the one or more clusters in the group or the one or more applications in the cluster. As illustrated in FIG. 4, the one or more waves are positioned in one or more quadrants in the graphical representation. The graphical representation of snapshot 400 is used for validating the sequencing of the one or more applications, clusters, and waves with the first set of users.

FIG. 5 illustrates a transition planning model 500 for identifying one or more transition activities, in accordance with an embodiment of the invention. Transition planning model 500 includes transition phases block 502, transition tracks block 504, transition context block 506, and transition activity types block 508.

Transition phases block 502 includes one or more transition phases. The transition phases are the key phases in the transition according to the defined transition process. For example, the transition phases include due diligence, transition planning, Knowledge Transfer (KT), secondary support, primary support, and transition closure.

Transition tracks block 504 includes one or more transition tracks. The transition tracks are the key areas that need to be focused as a part of the transition process. For example, application, infrastructure, Human Resource (HR), process integration, and business domain are some of the key transition tracks. The transition tracks ensure a holistic approach to the transition, and thus de-risk the whole transition process.

Transition context block 506 includes information that is captured as a part of the due-diligence phase. The key attributes that define transition context block 506 are portfolio assessment, engagement characteristics, and transition scenario. The key attributes of transition context block 506 have been explained in detail in conjunction with FIG. 1.

Transition activity types block 508 includes one or more transition activity types. The transition activity types are the activity types that are a part of the transition process. For example, engineering, knowledge management, operations, and management are some of the key activity types. The engineering activity types are related to activities around technical domain such as understanding application code and infrastructure set up whereas the knowledge management activity types are related to KT sessions, documentation work of knowledge, managing knowledge repository and validation of knowledge captured. The operations activity type are related to logistics work such as people movement, visa, travel arrangements, desktop allocations, and HR rebadging work, whereas management activity type is related to transition governance and program management.

Transition planning model 500 is used for identifying the one or more transition activities for transition execution. Firstly, based on transition context information captured as a part of portfolio analysis for each application, and transition risk rating, one or more transition tracks are selected from transition tracks block 504 as illustrated in table 10.

TABLE 10
Identification of Transition Tracks

| | Risk Ratings | Risk | Risk Ratings - | Risk |
|---|---|---|---|---|
| | Infrastructure | HR specific = | Ratings - Process | Ratings - Domain |
| | specific = | Medium/ | specific = | specific = |
| Track | Medium/High | High | Medium/High | Medium/High |
| Application | Mandatory | Mandatory | Mandatory | Mandatory |
| Infrastructure | Yes | NA | NA | NA |
| HR | NA | Yes | NA | NA |
| Process | NA | NA | Yes | NA |
| Domain | NA | NA | NA | Yes |

Then for each application based on application criticality rating, the transition phases are selected from transition phases block 502. Table 11 provides a reference mapping between the portfolio analysis attributes and the transition phases.

TABLE 11
Identification of Transition Phases

| Application | | | |
|---|---|---|---|
| Criticality/ | Knowledge | | |
| Application | Transfer | Secondary | |
| stability | Phase | support | Primary support |
| Low | Yes | Optional | Optional |
| Medium | Yes | Based on stability of | Based on stability |
| | | application it is | of application it is |
| | | required | required |
| High | Yes | Yes | Yes |

It will be evident to a person skilled in the art that due diligence, transition planning and transition closure phases are required for all applications.

Based on application complexity rating, the knowledge focus areas are selected. The one or more knowledge focus areas include domain knowledge, technical knowledge, tacit knowledge, and operations knowledge. The domain knowledge corresponds to understanding of the business process knowledge and business terms supported by the application(s). The technical knowledge focuses on the application functionality and interfaces, whereas the tacit knowledge focuses on gaining experimental knowledge of resolving application support issues. The operations knowledge is focused on gaining the application environment support knowledge. The knowledge focus areas are identified based on the application portfolio attributes such as business complexity and criticality, application stability, technology complexity, and service delivery complexity. Table 12 provides a reference mapping between the portfolio analysis attributes and the knowledge focus areas.

TABLE 12
Mapping between Portfolio Analysis Attributes and Knowledge focus areas

| Portfolio analysis | Domain | Technical | | Operations |
|---|---|---|---|---|
| attributes | Knowledge | Knowledge | Tacit Knowledge | Knowledge |
| Business knowledge | Yes | — | — | — |
| complexity | | | | |
| Technology Complexity | — | Yes | — | — |
| Application Stability | | Yes | Yes | Yes |
| Business Criticality | | Yes | Yes | Yes |
| Service Delivery | | | Yes | Yes |
| complexity | | | | |

For example, if an application has high business knowledge complexity, low technology complexity, high application stability, low business criticality, and low service delivery complexity, the knowledge focus area for the application will be focused on domain knowledge. Therefore, the one or more activities related to knowledge transfer in the domain knowledge will be identified.

Once the knowledge focus areas for each application are identified, then based on the transition scenario details and engagement characteristics, corresponding activity types and standard activities related to the activity types are selected. A rule engine of transition planning module 500 takes the various inputs explained above and executes the process of creation of transition plan using the default transition process and the estimation model for generating a tailored set of transition activities with effort estimates. Transition planning model 500 therefore assists in identifying the transition activities specific to environment context in which the transition phase will be executed. Therefore, the applicable transition activities are identified and mapped to corresponding phases of the transition execution based on transition planning model 500.

FIG. 6 illustrates a snapshot of a transition portfolio dashboard 600, in accordance with an embodiment of the invention.

As explained in conjunction with FIG. 1, transition portfolio dashboard 600 illustrates a graphical representation of the one or more organized transition plans at each cluster level. The one or more organized transition plans includes transition timelines, cluster information, resource plan for cluster, and key risks and mitigation steps as illustrated in transition portfolio dashboard 600. The transition timelines illustrate the time required for execution of the one or more transition activities of the organized transition plans. The cluster information provides details of the one or more applications in the one or more clusters and the sequencing of the one or more applications in the one or more clusters. The resource plan for cluster defines/details the effort and resources required for executing the one or more phases of the transition process. The key risks and mitigation steps define the one or more risks involved in the transition process and the steps to be performed for prevention and mitigation of the identified risks. The one or more organized transition plans are finally presented to the client. The transition of the one or more applications is executed based on the one or more organized transition plans.

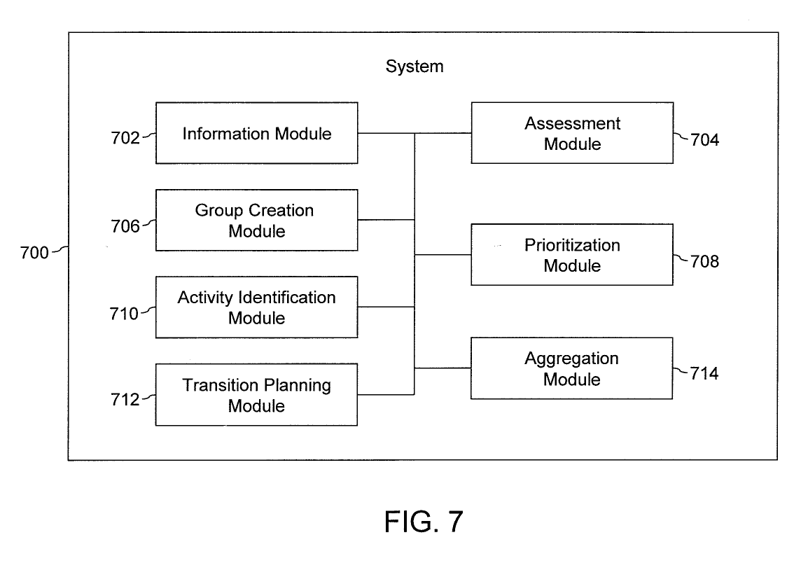

FIG. 7 is a block diagram of a system 700 for the generation of the one or more transition plans for the one or more applications of the organization, in accordance with an embodiment of the invention. System 700 includes information module 702, assessment module 704, group creation module 706, prioritization module 708, activity identification module 710, transition planning module 712, and aggregation module 714.

In various embodiments of the invention, system 700 illustrated in FIG. 7 is suitable for use in the transition of one or more applications of an organization. System 700 enables a user to generate the one or more transition plans to support and manage the transition of the one or more applications of the organization.

Information module 702 is configured for obtaining transition information from information corresponding to the one or more applications. The information corresponding to the applications (also referred to as application information) includes information describing the applications; for example, business domain of the application, complexity, criticality, and stability of the applications, and so forth. The information corresponding to the applications also includes information describing the environment in which the application is implemented; for example, programming language of the application, security compliance, and so forth. The information corresponding to the applications is captured using various tools and methods such as interview questionnaires and interview guides, reference application information, document repository tracker, RASCI matrix, 720-degree framework as explained in conjunction with FIG. 1.

The above mentioned tools and/or methods are then used for obtaining transition information as explained in conjunction with FIG. 1. The transition information includes information captured in various dimensions such as portfolio complexity, engagement characteristics, and transition scenarios. Thereafter, the transition information is used for identifying a set of applications for transition. The set of applications is identified from the one or more applications of the organization.

Each of the one or more applications is assessed for obtaining the transition information. Assessment module 704 is configured for enabling a user such as a transition manager to assess the one or more applications. The assessment of the one or more applications is performed based on the information corresponding to the one or more applications. The application information obtained from all the stakeholders such as business group, IT management group, and service provider is used for assessing the applications for transition. The assessment of the one or more applications of the organization has been explained in detail in conjunction with FIG. 2.

One or more groups (also referred to as waves) of the identified set of applications are created. Group creation module 706 is configured for creating the one or more groups. A group is defined as a unit of transition period. It guides or enables the transition manager to formulate an execution plan for the transition. The one or more groups of the identified set of applications are created based on a predefined set of criteria as explained in conjunction with FIG. 1. The one or more groups are also sequenced or prioritized for transition execution based on the predefined set of criteria as explained in conjunction with FIG. 1. The predefined set of criteria includes various attributes such as gradual ramp up of steady state team, enabling learning across groups, SME requirement, and transition risk.

Each of the one or more groups comprises one or more clusters. Each of the one or more clusters comprises the identified set of applications. A cluster is defined as a logical grouping of applications based on various factors such as synergies between applications in terms of technology, domain, lines of business, manager-in-charge; dependencies among applications being clustered; and involving manageable number of resources. The clusters are mapped to the one or more groups based on various factors such as cluster criticality and cluster transition risk as explained in conjunction with FIG. 1.

In an embodiment of the invention, assessment module 704 is further configured to enable a user assess the one or more clusters containing different applications. The one or more clusters are assessed on the basis of one or more scores of the applications included in the corresponding clusters as explained in conjunction with FIG. 1. Various scoring techniques are used to determine the scores of the one or more applications as explained in conjunction with FIG. 2.

In an embodiment of the invention, a graphical representation of the one or more clusters is generated on the basis of the assessment of the clusters, i.e., one or more attributes of the applications such as complexity, and criticality. Various clusters containing different applications and classified based on their business domains are represented graphically in various formats such as pie charts, scatter charts, and bubble charts. Further, a graphical representation of the one or more groups is generated as illustrated in FIG. 4. The graphical representation of the groups is generated based on the various attributes such as complexity, and business criticality.

The one or more clusters in the one or more groups are prioritized for transition sequencing. Prioritization module 708 is configured to enable a user such as a transition manager prioritize or sequence each of the one or more clusters in the one or more groups. The prioritization or sequencing of the clusters within the groups is based on cluster transition risk or cluster stability as explained in conjunction with FIG. 1. The prioritization of the one or more clusters includes prioritization of the identified set of applications in the one or more clusters. Each application is prioritized for transition sequencing in the corresponding cluster as explained in conjunction with FIG. 1.

One or more activities, also referred to transition activities, are identified for transition execution. Activity identification module 710 is configured for identifying the one or more transition activities. The transition activities refer to the activities or tasks that need to be performed during the transition process. The transition activities include, transition kick off, review of overall transition plan, and so forth. In other words, the transition activities refer to the activities that need to be performed during different phases of the transition process; for example, due diligence, transition planning, knowledge transfer, secondary support, primary support, and transition closure. The one or more activities are identified for each application of the identified set of applications in the one or more groups. The one or more activities are identified based on the transition information and one or more transition rules. The one or more transition rules comprise at least one of one or more knowledge focus areas, one or more transition phases, one or more transition tracks, and one or more transition activity types. The identification of the one or more activities has been explained in detail in conjunction with FIG. 5.

Transition planning module 712 is configured for generating the one or more transition plans. The one or more transition plans include the one or more identified activities corresponding to the identified set of applications. The generation of the transition plans, as explained in conjunction with FIG. 1, includes defining transition estimates based on the complexity of the activity. The transition estimates include estimation of the total transition effort and schedule.

Transition planning module 712 is further configured to enable a user assign resources to each of the one or more identified activities in the one or more transition plans. The resources such as infrastructure and workforce are assigned to each of the one or more identified activities in the one or more transition plans. Thereafter, effort and timelines for execution of the one or more identified activities are estimated using transition planning module 712. The effort estimation has been explained in detail in conjunction with FIG. 1. Further, a schedule or timelines for the execution of the identified activities is defined by a user such as a transition manager using transition planning module 712. The schedule is defined at a group level, a cluster level and an application level. The defining of the schedule includes defining dependencies within the various activities at the application level, the cluster level and the group level.

Subsequently, the transition plans corresponding to the identified set of applications are aggregated. Aggregation module 714 is configured for aggregating the one or more transition plans based on the one or more groups and the one or more clusters as explained in conjunction with FIG. 1. The transition plans corresponding to the applications in a single cluster are aggregated. Thereafter, the transition plans corresponding to all the clusters in a group/wave are aggregated, and thus an aggregated transition plan (also referred to as a group-level transition plan) is created. The aggregated transition plans, also referred to as draft transition plans, are then presented to the client. In an embodiment of the invention, the aggregated transition plans are represented in a graphical format.

In an embodiment of the invention, transition planning module 712 is further configured to enable the user such as a transition manager identify one or more risks associated with each of the one or more identified activities. The risks and/or issues are identified at each of the levels, i.e., at an activity level, an application level, a cluster level, and a group level. Further, transition planning module 712 is configured for organizing the one or more transition plans. The transition plans are organized or baselined based on the one or more identified risks and/or issues as explained in conjunction with FIG. 1.

In an embodiment of the invention, transition planning module 712 is further configured for generating a graphical representation of the one or more organized transition plans. The graphical representation of the one or more organized transition plans is illustrated in FIG. 6. The one or more organized transition plans are finally presented to the client. The transition of the one or more applications is executed based on the one or more organized transition plans.

FIG. 8 is a block diagram of a system 800 for assessing the one or more applications for transition, in accordance with an embodiment of the invention. System 800 (also known as 720 degree framework) includes portfolio scoring module 802, portfolio validation module 804, identification module 806, and post-transition analysis module 808.

In various embodiments of the invention, system 800 illustrated in FIG. 8 is suitable for use in assessing the one or more applications for transition from a first set of users to a second set of users. System 800 enables a user to support and manage the assessment of the one or more applications of the organization.

For each of the one or more applications of the organization, a first set of scores is defined by a first set of users. The first set of users includes stakeholders from the IT management group, i.e., technology SME. Portfolio scoring module 802 is configured to enable the first set of users define the first set of scores. The first set of scores is defined based on information corresponding to the one or more applications. As explained in conjunction with FIG. 1, the information corresponding to the applications (also referred to as application information) includes information describing the applications; for example, business domain of the application, complexity, criticality and stability of the applications, process area, ease of maintenance, transition risk, service complexity, and so forth. The first set of scores will be defined based on application features in alignment with business process, application performance and the application information. Therefore, the assessment of the clusters or the applications includes a multi-dimensional analysis of the information corresponding to the applications.

Portfolio scoring module 802 is further configured to enable a second set of users define a second set of scores for each of the one or more applications. The second set of users includes stakeholders from the vendor or the service provider assisting in the transition of the one or more applications. The second set of scores is defined based on available transition information and one or more historical scores stored in a repository. The second set of users search the historical repository based on the business domain and key functionality of the application. Thereafter, the one or more historical scores are retrieved from the historical repository based on one or more dimensions such as transition risk, service complexity, ease of maintenance, complexity, and stability of the applications as explained in conjunction with FIG. 2.

Portfolio scoring module 802 takes the application information and interview data as input and uses them to analyze application for assessment of transition to a different organization and/or location. Therefore, the output of portfolio scoring module 802 is application assessment. The key components of portfolio scoring module 802 are as follows:
Application information repository: This is a repository of application-related details for a particular portfolio. The application information repository includes the application information and interview data of the first set of users as explained in conjunction with FIG. 1. The application information consists of application attributes that are key to decision making for transition. For example, application availability performance, business criticality, technology, Service Level Agreements, and so forth.
Application scoring guidelines: This provides the scoring rules that need to be used during the evaluation of each of the one or more applications. The applications score is typically in the range of 1-5.
Reference analysis model: Based on the objective of analysis, the application information and historical information of related business domain, system 800 will derive the necessary reference analysis model, dimensions for scoring the applications, and weights for the dimensions.
Application analysis model: This model is used for analyzing applications for transition and for designing the transition approach based on the application scores. Some application attributes are also defined for generating the application analysis model used in application and support dimension of the 720-degree framework. The application attributes include complexity such as application and service complexity, supportability in terms of application stability and process maturity, transition risk, and criticality such as business and onsite criticality. Each of the application attributes is assigned a weightage and a score is calculated for each attribute based on predefined scoring guidelines. The scores of the application attributes are thus used for generating the application analysis model.
Application scoring repository: This is a historical repository, as explained in conjunction with FIGS. 2 and 3, that stores information of application scores of previous engagement for various applications spanned across industries. The one or more historical scores stored in the repository correspond to scores captured post the transition of the one or more applications.
2*2 Plots: These plots are decision-making tools used for deciding the right or appropriate cluster of applications and sequencing of applications for transition.

The first set of scores and the second set of scores defined using portfolio scoring module 802 are validated. Portfolio validation module 804 enables the first set of users and the second set of users to validate the first set of scores and the second set of scores. The first set of scores and the second set of scores are compared to identify differences or gaps between them. The first set of scores and the second set of scores are then validated based on the identified differences as explained in conjunction with FIG. 2. The first set of scores and the second set of scores and the identified differences are presented to the first set of users and the second set of users for validation.

In an embodiment of the invention, the validated set of scores includes the scores that are identified from the first set of scores and the second set of scores based on the validation performed by the first set of users and the second set of users. The validated set of scores is used for assessing the one or more applications for transition as explained in conjunction with FIGS. 1 and 2.

Portfolio validation module 804 takes IT community scoring as an input and uses them to analyze application for assessment of transition to a different organization and/or location. The IT community scoring includes the first set of scores and the second set of scores provided by the first set of users and the second set of users respectively. Thereafter, portfolio validation module 804 determines assessment of transition to a different organization and/or location of the one or more applications based on the validated set of scores.

Identification module 806 is configured to enable a user identify one or more transformation opportunities for the one or more applications. The transformation opportunities are the areas of improvement and areas of value addition to existing IT services and application portfolio in the context of value provided to business. The transformation opportunities are of three types—business level, technology and process—as explained in conjunction with FIG. 3. The one or more transformation opportunities are identified based on the assessment of the one or more applications as explained in conjunction with FIG. 3.

Identification module 806 is further configured for enabling a third set of users to identify a third set of scores for each of the one or more applications. The third set of scores are identified by the third set of users based on the validation of the first set of scores and second set of scores as explained in conjunction with FIG. 2. The third set of users is the business users who are using one or more applications for day-to-day transactions. The applications are provided the third set of scores on the basis of different parameters or dimensions such as business value delivered, cost of service delivered, quality of service provided and risk exposure.

Identification module 806 is used for analyzing the risks based on service capability assessment and identifies transformation opportunities based on transformational assessment. Identification module 806 includes the following key components:
Capability risk assessment inputs: Various inputs that are captured to perform risk assessment for each cluster within the portfolio include: service capability requirements, current team skill details and skill requirements, process maturity level, Service Level Agreements (SLAB) and Operational Level Agreements, and existing contract details. These inputs are captured based on interview with application team, analyzing the current SLA performance, discussion with IT group on SLA goals and assessment of maturity level of current support process.
Service Capability assessment: Based on the capability risk assessment inputs at cluster level, the transition risk assessment is performed with regard to engagement commitments and resource capability. The capability risk assessment inputs are referred, and thus scores are given with regard to engagement commitment dimension and capability requirement dimension respectively. Table 13 helps in identifying the transition risk from execution perspective and helps in de-risking the transition by factoring necessary mitigation steps as a part of transition plan.

TABLE 13
Identification of Transition Risks

| Engagement | Capability | Transition | |
|---|---|---|---|
| Commitment | Requirement | Risk | |
| Rating | Rating | Rating | Possible Mitigation steps |
| High | High | High | Rebadged to mitigate capability requirement, |
| | | | transition estimates to factor for |
| | | | engagement commitments and senior team |
| | | | members to be part of this cluster transition |
| | | | team |
| High | Low | Medium | Transition estimates to factor for |
| | | | engagement commitments and senior team |
| | | | members to be part of this cluster transition |
| | | | team |
| Low | High | Medium | Rebadged to mitigate capability requirement |
| Low | Low | Low | None |

Bench Mark index: This is the historical set of scores that is collated based on past engagements. These scores are stored for a particular industry domain and business process. The average assessment score at business process level that is evaluated as a part of transformational assessment is compared with industry standards or historical data and the comparison is then used for the identification of areas of transformation opportunities as explained in conjunction with FIG. 3.
Transformational assessment: There are two levels of assessment performed at application level. On a technology stand point, the first set of users and the second set of users come up with the validated set of scores as explained in conjunction with FIG. 2. Further, the third set of users (such as business users) perform the application level assessment on various key attributes such as business value delivered, cost of service delivered, quality of service provided and risk exposure of applications from point of view of business execution, technology and operations. The correlation analysis of the validated set of scores and the third set of scores is performed and along with bench mark index value for the business process supported by application, corresponding transformation opportunities are identified.
Transformational Opportunity list and plan: This is the list of transformation opportunities that are identified based on transformational opportunity assessment and bench mark index. The typical areas covered by the transformation opportunities include increasing revenues, decreasing cost of operations, increasing regulatory compliance, and improving HR and governance processes. Further, a transformation plan is prepared based on operational initiatives and the transformation opportunities. The transformation plan provides details of the activities to be performed by the second set of users or service provider.

Once the transformation opportunities are identified, one or more transition plans are generated and executed for the one or more applications as explained in conjunction with FIGS. 1 and 3. Thereafter, one or more post-transition scores are identified and stored in a repository (also known as historical repository). Post-transition analysis module 808 is configured for identifying the one or more post-transition scores for each of the one or more applications. The post-transition scores include scores captured based on feedback from the following areas/domains: wave and cluster performance, application scores, and application transition performance. The one or more post-transition scores are identified based on transition execution. The post-transition scores are used in the assessment of the one or more applications in the subsequent transition processes as explained in conjunction with FIG. 2. Post-transition analysis module 808 is further configured for analyzing differences between the third set of scores and the one or more post-transition scores for updating the assessment of the one or more applications. Thereafter, the one or more post-transition scores are stored in the repository using post-transition analysis module 808. The identification and storage of the one or more post-transition analysis scores has been explained in detail in conjunction with FIGS. 1 and 3.

Post-transition analysis module 808 captures the post-transition performance details and post-transition analysis details. Post-transition analysis module 808 includes the following key component:
Feedback Module: This module helps capture the application ratings/scores on multiple dimensions, cluster definition, wave performance details, and actual timelines. Input to the feedback module includes the IT community scoring, the one or more post-transition scores and the actual transition effort. The information is then passed on to application scoring repository and transition historical repository is generated as an output.

In an embodiment of the invention, the identification of the one or more post-transition scores performed by post-transition analysis module 808 is performed prior to the identification of the one or more transformation opportunities by identification module 806. In other words, functionalities of post-transition analysis module 808 and identification module 806 can be performed interchangeably.

The method and the system described above have a number of advantages. The method and the system facilitate multi-dimensional, context-based transition approach for effective transition. Further, the present invention enables closed-loop learning by capturing information gaps and by sharing the learning's from the transition with the users post transition. It enables building of knowledge on application scoring models or historical information for various portfolios/domains over a period of time which can later be used as a reference. It also provides collaboration between stakeholders to analyze the portfolio, thereby providing a holistic view of applications from multiple stakeholders' view points. The present invention reduces the dependency on transition manager's expertise and experience by using a data driven approach for generating the transition plans.

The system for generating one or more transition plans for one or more application of an organization, as described in the present invention or any of its components, may be embodied in the form of a computer system. Typical examples of a computer system include a general-purpose computer, a programmed microprocessor, a micro-controller, a peripheral integrated circuit element, and other devices or arrangements of devices that are capable of implementing the steps that constitute the method of the present invention.

The computer system comprises a computer, an input device, a display unit, and the Internet. The computer further comprises a microprocessor, which is connected to a communication bus. The computer also includes a memory, which may include Random Access Memory (RAM) and Read Only Memory (ROM). The computer system also comprises a storage device, which can be a hard disk drive or a removable storage drive such as a floppy disk drive and an optical disk drive. The storage device can also be other similar means for loading computer programs or other instructions into the computer system. The computer system also includes a communication unit, which enables the computer to connect to other databases and the Internet through an Input/Output (I/O) interface. The communication unit also enables the transfer and reception of data from other databases. The communication unit may include a modem, an Ethernet card, or any similar device which enable the computer system to connect to databases and networks such as Local Area Network (LAN), Metropolitan Area Network (MAN), Wide Area Network (WAN), and the Internet. The computer system facilitates inputs from a user through an input device, accessible to the system through an I/O interface.

The computer system executes a set of instructions that are stored in one or more storage elements, in order to process the input data. The storage elements may also hold data or other information as desired. The storage element may be in the form of an information source or a physical memory element present in the processing machine.

The present invention may also be embodied in a computer program product for generating one or more transition plans for one or more application of an organization. The computer program product includes a computer-usable medium having a set program instructions comprising a program code for generating one or more transition plans for one or more application of an organization. The set of instructions may include various commands that instruct the processing machine to perform specific tasks such as the steps that constitute the method of the present invention. The set of instructions may be in the form of a software program. Further, the software may be in the form of a collection of separate programs, a program module with a large program, or a portion of a program module, as in the present invention. The software may also include modular programming in the form of object-oriented programming. The processing of input data by the processing machine may be in response to user commands, results of previous processing, or a request made by another processing machine.

While the preferred embodiments of the invention have been illustrated and described, it will be clear that the invention is not limit to these embodiments only. Numerous modifications, changes, variations, substitutions, and equivalents will be apparent to those skilled in the art without departing from the spirit and scope of the invention, as described in the claims.

1. A computer-implemented method for generating one or more transition plans for one or more applications supporting at least one function of an organization, the method comprising:
a. obtaining transition information from information corresponding to the one or more applications, the transition information being obtained for identifying a set of applications for transition, the set of applications being identified from the one or more applications;
b. creating one or more groups of the identified set of applications, each of the one or more groups comprising one or more clusters, the one or more clusters comprising the identified set of applications;
c. identifying one or more activities for transition execution, the one or more activities being identified for each application of the identified set of applications in the one or more groups, wherein the one or more activities are identified based on the transition information and one or more transition rules; and
d. generating the one or more transition plans, the one or more transition plans comprising the one or more identified activities corresponding to the identified set of applications.

2. The method of claim 1 further comprising assessing each of the one or more applications for obtaining the transition information, the assessment being performed based on the information corresponding to the one or more applications.

3. The method of claim 1, wherein the one or more transition rules comprises at least one of one or more knowledge focus areas, one or more transition phases, one or more transition tracks, and one or more transition activity types.

4. The method of claim 1, wherein the one or more groups of the identified set of applications are created based on a predefined set of criteria.

5. The method of claim 1 further comprising prioritizing each of the one or more clusters in the one or more groups for transition sequencing, wherein prioritizing each of the one or more clusters comprises prioritizing each application of the identified set of applications in the corresponding clusters.

6. The method of claim 1 further comprising aggregating the one or more transition plans corresponding to the identified set of applications, the aggregation being based on the one or more clusters and the one or more groups.

7. The method of claim 1 further comprising:
a. assigning resources to each of the one or more identified activities in the one or more transition plans;
b. estimating effort and timelines for execution of the one or more identified activities;
c. identifying one or more risks associated with each of the one or more identified activities; and
d. organizing the one or more transition plans based on the one or more identified risks.

8. The method of claim 7 further comprising generating a graphical representation of the one or more organized transition plans.

9. A computer-implemented method for assessing one or more applications supporting at least one function of an organization, the one or more applications being assessed for transition from a first set of users to a second set of users, the method comprising:
a. defining a first set of scores for each of the one or more applications, the first set of scores being defined by the first set of users based on information corresponding to the one or more applications;
b. defining a second set of scores for each of the one or more applications, the second set of scores being defined by the second set of users based on one or more historical scores stored in a repository; and
c. validating the first set of scores and the second set of scores based on differences between the first set of scores and the second set of scores, the validation being performed by the first set of users and the second set of users; wherein, the one or more applications are assessed based on the validated set of scores.

10. The method of claim 9 further comprising:
a. identifying a third set of scores for each of the one or more applications based on the validation, the third set of scores being identified by a third set of users; and
b. identifying one or more transformation opportunities for the one or more applications, the one or more transformation opportunities being identified based on the third set of scores and the validated set of scores.

11. The method of claim 9 further comprising:
a. identifying one or more post-transition scores for each of the one or more applications, wherein the one or more post-transition scores are identified based on transition execution;
b. analyzing differences between the validated set of scores and the one or more post-transition scores for updating the assessment of the one or more applications; and
c. storing the one or more post-transition scores in the repository.

12. A system for generating one or more transition plans for one or more applications supporting at least one function of an organization, the system comprising:
a. an information module configured for obtaining transition information from information corresponding to the one or more applications, the transition information being obtained for identifying a set of applications for transition, the set of applications being identified from the one or more applications;
b. a group creation module configured for creating one or more groups of the identified set of applications, each of the one or more groups comprising one or more clusters, the one or more clusters comprising the identified set of applications;
c. an activity identification module configured for identifying one or more activities for transition execution, the one or more activities being identified for each application of the identified set of applications in the one or more groups, wherein the one or more activities are identified based on the transition information and one or more transition rules; and
d. a transition planning module configured for generating the one or more transition plans, the one or more transition plans comprising the one or more identified activities corresponding to the identified set of applications.

13. The system of claim 12 further comprising an assessment module configured for enabling a user to assess each of the one or more applications for obtaining the transition information, the assessment being performed based on the information corresponding to the one or more applications.

14. The system of claim 12, wherein the one or more transition rules comprises at least one of one or more knowledge focus areas, one or more transition phases, one or more transition tracks, and one or more transition activity types.

15. The system of claim 12, wherein the one or more groups of the identified set of applications are created based on a predefined set of criteria.

16. The system of claim 12 further comprising a prioritization module configured for enabling a user to prioritize each of the one or more clusters in the one or more groups for transition sequencing, wherein prioritizing each of the one or more clusters comprises prioritizing each application of the identified set of applications in the corresponding clusters.

17. The system of claim 12 further comprising an aggregation module configured for aggregating the one or more transition plans corresponding to the identified set of applications, the aggregation being based on the one or more clusters and the one or more groups.

18. The system of claim 12, wherein the transition planning module is further configured for:
a. enabling a user to assign resources to each of the one or more identified activities in the one or more transition plans;
b. estimating effort and timelines for execution of the identified activities;
c. enabling the user to identify one or more risks associated with each of the one or more identified activities; and
d. organizing the one or more transition plans based on the one or more identified risks.

19. The system of claim 18, wherein the transition planning module is further configured for generating a graphical representation of the one or more organized transition plans.

20. A system for assessing one or more applications supporting at least one function of an organization, the one or more applications being assessed for transition from a first set of users to a second set of users, the system comprising:
a. a portfolio scoring module configured for:
i. enabling the first set of users to define a first set of scores for each of the one or more applications, the first set of scores being defined based on information corresponding to the one or more applications; and
ii. enabling the second set of users to define a second set of scores for each of the one or more applications, the second set of scores being defined based on one or more historical scores stored in a repository; and
b. a portfolio validation module configured for enabling the first set of users and the second set of users to validate the first set of scores and the second set of scores, the validation being performed based on differences between the first set of scores and the second set of scores, wherein, the one or more applications are assessed based on the validated set of scores.

21. The system of claim 20 further comprising an identification module configured for:
a. enabling a third set of users to identify a third set of scores for each of the one or more applications, the third set of scores being identified based on the validation; and
b. enabling a user to identify one or more transformation opportunities for the one or more applications, the one or more transformation opportunities being identified based on the third set of scores and the validated set of scores.

22. The system of claim 20 further comprising a post-transition analysis module configured for:
a. identifying one or more post-transition scores for each of the one or more applications, wherein the one or more post-transition scores are identified based on transition execution;
b. analyzing differences between the validated set of scores and the one or more post-transition scores for updating the assessment of the one or more applications; and
c. storing the one or more post-transition scores in the repository.

23. A computer program product for use with a computer, the computer program product comprising a computer usable medium having a computer readable program code embodied therein for generating one or more transition plans for one or more applications supporting at least one function of an organization, the computer readable program code performing:
a. obtaining transition information from information corresponding to the one or more applications, the transition information being obtained for identifying a set of applications for transition, the set of applications being identified from the one or more applications;
b. creating one or more groups of the identified set of applications, each of the one or more groups comprising one or more clusters, the one or more clusters comprising the identified set of applications;
c. identifying one or more activities for transition execution, the one or more activities being identified for each application of the identified set of applications in the one or more groups, wherein the one or more activities are identified based on the transition information and one or more transition rules; and
d. generating the one or more transition plans, the one or more transition plans comprising the one or more identified activities corresponding to the identified set of applications.

24. The computer program product of claim 23, wherein the one or more transition rules comprises at least one of one or more knowledge focus areas, one or more transition phases, one or more transition tracks, and one or more transition activity types.

25. The computer program product of claim 23, wherein the one or more groups of the identified set of applications are created based on a predefined set of criteria.

26. The computer program product of claim 23, wherein the computer readable program code further performs aggregating the one or more transition plans corresponding to the identified set of applications, the aggregation being based on the one or more clusters and the one or more groups.

27. The computer program product of claim 23, wherein the computer readable program code further performs generating a graphical representation of the one or more transition plans.
